(19) United States
(12) Patent Application Publication
(10) Pub. No.: US 2019/0007258 A1
(43) Pub. Date: Jan. 3, 2019

(54) WORKLOAD PLACEMENT AND RESOURCE ALLOCATION FOR MEDIA PRODUCTION DATA CENTER

(71) Applicant: CISCO TECHNOLOGY, INC., San Jose, CA (US)

(72) Inventors: Andre Surcouf, Saint Leu La Foret (FR); Yoann Desmouceaux, Paris (FR)

(73) Assignee: CISCO TECHNOLOGY, INC., San Jose 95134, CA (US)

(21) Appl. No.: 15/638,166

(22) Filed: Jun. 29, 2017

(51) Int. Cl. H04L 29/08; G06F 1/20; G06F 1/32; G06F 17/30

(52) U.S. Cl. CPC H04L 29/08144; G06F 1/206; H04L 67/10; H04L 29/06; G06F 17/30017; H04L 29/08153; G06F 1/3203

(57) ABSTRACT

In one embodiment, a method includes characterizing a set of compute nodes, wherein the set of compute nodes comprise a network; characterizing a set of workloads, wherein the set of workloads comprise at least one application executing on the network; for each workload of the set of workloads, attempting to assign the workload to a compute node of the set of compute nodes based on the characterizing the set of compute nodes and the characterizing the set of workloads; determining whether each one of the workloads of the set of workloads has been successfully assigned to a compute nodes of the set of compute nodes; and if each one of the workloads of the set of workloads has been successfully assigned to a compute node of the set of compute nodes, awaiting a change in at least one of the set of compute nodes and the set of workloads.

### TECHNICAL FIELD

This disclosure relates in general to the field of data center networks and, more particularly, to techniques for workload placement and resource allocation techniques for media production data center networks.

### BACKGROUND

Live media production is characterized by a high-volume of low-latency media traffic, predictable delays, and near-zero packet loss. Currently, live media production is primarily performed using bespoke physical appliances, with only a limited number of solutions leveraging cloud- and data center-based solutions. Solutions for live media production using commodity hardware is a significant and important challenge given the current need for cost containment and optimization. The challenge is not trivial, given the fact that the current TCP/IP network stack was designed for a best-effort and asynchronous service model in an uncontrolled environment (i.e., the Internet), which is not well-suited for network-greedy applications, such as real-time and fault-tolerant video processing in a controlled environment as utilized by the media production industry.

A cloud based media production system may be characterized by management of media service chains, wherein the media is generated using one or more cameras and/or microphones. Once generated, the media is distributed through one or media functions, or media service chains. The media service (or production) may be crafted by composing composite models including cloud assets, physical assets and networking functions. Deployment constraints may include latency, bandwidth, packet loss and other types of requirements.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a simplified block diagram of a system in which techniques for optimizing workload placement and resource allocation for a network (e.g., a media production data center) in accordance with embodiments described herein;

FIG. 2 illustrates a simplified block diagram of an embodiment of a flow-aware scheduler for optimizing workload placement and resource allocation for a network (e.g., a media production data center) in accordance with embodiments described herein;

FIG. 3 illustrates another simplified block diagram of a system in which techniques for optimizing workload placement and resource allocation for a network (e.g., a media production data center) in accordance with embodiments described herein;

FIG. 4 illustrates an example algorithm that may be executed by the flow-aware scheduler of FIG. 2 for implementing techniques for optimizing workload placement and resource allocation for a network (e.g., a media production data center) in accordance with embodiments described herein;

FIG. 5 illustrates a flowchart showing example steps of techniques for optimizing workload placement and resource allocation for a network (e.g., a media production data center) in accordance with embodiments described herein; and

FIG. 6 is a simplified block diagram of a machine comprising an element of a communications network in which techniques for optimizing workload placement and resource allocation for a network (e.g., a media production data center) in accordance with embodiments described herein may be implemented.

### DETAILED DESCRIPTION OF EXAMPLE EMBODIMENTS

### Overview

In one embodiment, a method includes characterizing a set of compute nodes, wherein the set of compute nodes comprise a network; characterizing a set of workloads, wherein the set of workloads comprise at least one application executing on the network; for each workload of the set of workloads, attempting to assign the workload to a compute node of the set of compute nodes based on the characterizing the set of compute nodes and the characterizing the set of workloads; determining whether each one of the workloads of the set of workloads has been successfully assigned to a compute nodes of the set of compute nodes; and if each one of the workloads of the set of workloads has been successfully assigned to a compute node of the set of compute nodes, awaiting a change in at least one of the set of compute nodes and the set of workloads.

### Example Embodiments

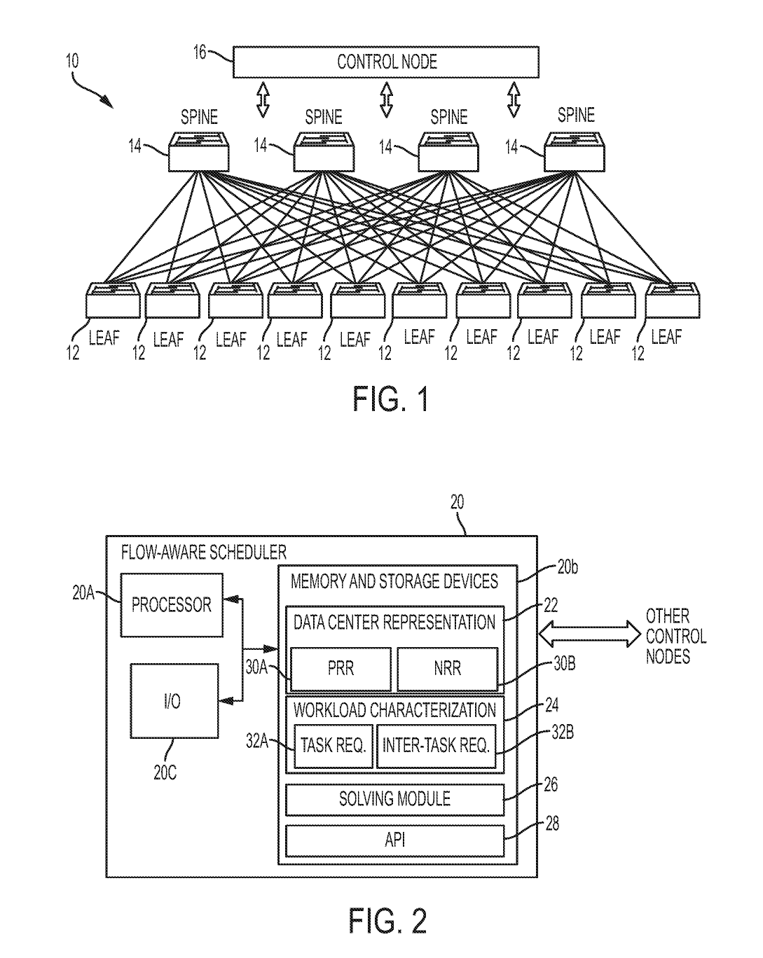

FIG. 1 is a simplified block diagram of a media production data center network 10 including features of embodiments described herein for optimizing workload placement and resource allocation. As shown in FIG. 1, the media production data center network 10 is implemented using a spine-leaf topology that includes multiple leaf switches 12 each connected to multiple spine switches 14. The network 10 further includes one or more control and/or orchestrator nodes, represented in FIG. 1 by a generically designated controller 16, for enabling configuration of the switches 12, 14, providing orchestration functions, and/or controlling traffic through the network 10. The topology supports any combination of leaf switches, including use of just a single type of leaf switch. Media sources and receivers may connect to the leaf switches 12 and receivers may initiate Internet Group Management Protocol (“IGMP”) join requests to the leaf switches 12 in order to receive media traffic from the network 10.

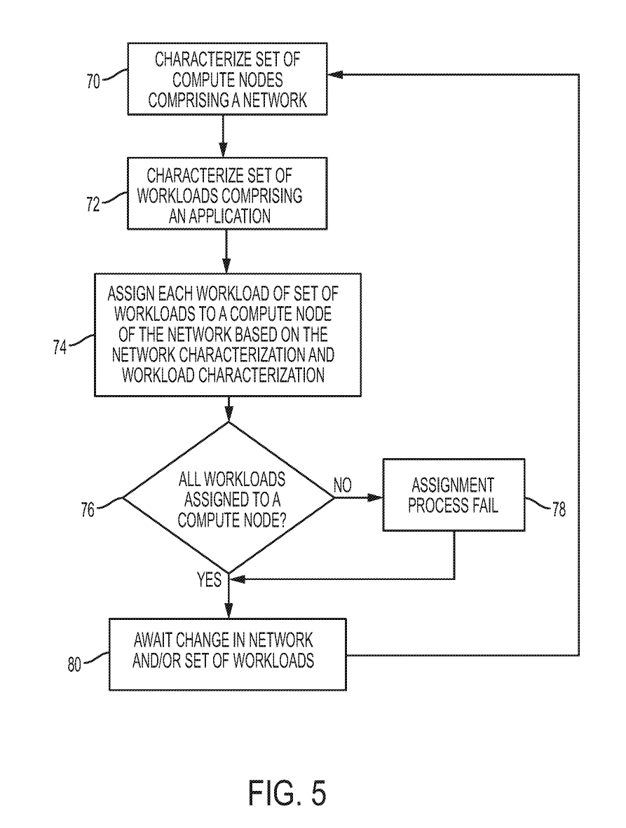

To properly address the myriad issues that arise in the context of allocating and/or reallocating workloads that are part of a media production pipeline within a media production data center, embodiments described herein introduce an element referred to as a network-aware workload scheduler, or “flow-aware scheduler”. Referring now to FIG. 2, illustrated therein is a simplified block diagram of an embodiment of a flow-aware scheduler 20, which embodies a model that goes beyond traditional cloud workload schedulers and may be implemented as a standalone orchestrator or as a plug-in to existing schedulers, thus extending scheduling capabilities while maintaining backward compatibility with existing deployment schemes. The flow-aware scheduler 20 includes a processor 20A, memory 20B, and I/O devices 20C, as well as operational four components, or modules, 22-28, each of which may include software embodied in one or more tangible media for facilitating the activities described hereinbelow. For example, solver 26 may include software for implementing the steps described with reference to FIG. 5 below. Processor 20A is capable of executing software or an algorithm, such as embodied in modules 22-28, to perform the functions discussed in this specification. Memory 20B may be used for storing information to be used in achieving the functions as outlined herein.

Turning now to the modules 22-28, a data center representation 22 includes a global view of the data center resources, including physical machines and network. A workload characterization 24 is represented by a graph of workloads to be scheduled. A solving module 26 yields correct placement of workloads with respect to the resource and demand constraints. Finally, an application programming interface (“API”) 28 provides a means through which an external agent can inject configuration to modify the aforementioned data center representation 22 and the workload characterization 24, invoke the solving module 26, and retrieve a correct placement of workloads with respect to the resource and demand constraints.

In order to be able to correctly place media workloads on compute nodes according to static (e.g., central processing unit (“CPU”), memory, graphics processing unit (“GPU”), etc.) requirements of the workload itself and, equally importantly, network requirements, the data center representation 22 comprises an overview of those machines (or compute nodes) constituting the media data-center, as well as the precise topology of the network on which they reside. For each machine in the media data-center, a representation of the machine (referred to herein as a “physical resources representation” (or “PRR”) 30A) is maintained. The physical resources representation may include features such as CPU and memory capacity and may be extended to any kind of physical resource, such as GPU, storage, etc. In certain embodiments, the information is injected into the system via the API (described in greater detail below). A “network resources representation” (or “NRR”) 30B is a labeled oriented graph maintained by the system and which represents the topology of the network. The network resources representation 30B is also injected via the API 28. For each routing node (switch or router) in the network, an edge is created in the network resources graph. Similarly, for each physical machine in the network an edge is created in the network resources graph. Finally, for each physical link in the network, a vertex is maintained in the graph, labeled with the link capacity.

As explained hereinabove, media production data centers will typically run pipelines, each of which may include several workloads that are chained together. For instance, in a general scenario, a pipeline could include four workloads, respectively designated w1, w2, w3, w4, with fixed bandwidth demands between a source and w1, w1 and w2, w2 and w3, w3 and w4, w4 and a destination, with the source and destinations possibly lying outside of the media data center. It will be recognized that more intricate scenarios may occur, for example, scenarios in which a pipeline forks or merges. To accommodate the general scenario presented above, the workload characterization 24 may adopt an abstract model that includes “task requirements” 32A and “inter-task requirements” 32B. The task and inter-task requirements may be pushed to the model via the API 29 depending on deployment needs.

For each task in the media data-center, CPU and memory requirements are maintained (as explained above, this can be extended to any scalar resources, including GPU and storage); these are referred to herein as task requirements 32A. For each pair of communicating tasks (e.g., w1->w2 in the example above), inter-task requirements 32B, such as a throughput demand, is maintained. The throughput demand expresses the throughput at which the first task will send data to the second one.

Once the physical description of the data-center as well as the workload characterization 24 have been pushed to the flow-aware scheduler, the solving module 26, or “solver,” can be invoked in order to obtain a correct allocation of the tasks. Once the solver 26 returns a result and places a workload on a compute node, it will also maintain an internal state containing the allocation that has been computed. This way, if the network operator needs to remove some workloads or deploy new ones, the solver 26 will be able to compute a new allocation based on the current state of the data center.

The internal algorithm used by the solving module 26 may be of any type, as long as the task requirements 32A and inter-task requirements 32B formulated in the workload characterization 24 match the available physical resources and network resources as expressed in the data-center representation 22. In one embodiment, this may be formulated as a Mixed Integer Linear Programming (“MILP”) model and solved using a linear programming technique such as the simplex algorithm. The solving module 26 will be described in greater detail hereinbelow.

The API module 28 manages communications between the flow-aware scheduler and other controlling nodes in the media data center. The API provides functions for initially specifying a data center representation 22, adding or removing elements comprising the workload characterization 24, running the solving module 26, and retrieving the current allocation state as computed by the solving module. In certain embodiments, the API may take the form of an HTTP REST API or a library to be plugged into an already existing network orchestrator. A tight integration within an existing orchestrator could provide automation of certain tasks, such as automatically deriving the data center representation 22.

Furthermore, the data center representation 22 could be automatically obtained thanks to the use of introspection techniques (e.g., discovery of the path via traceroute and of the available bandwidth via iperf).

Referring again to the data center representation 22 referenced above, embodiments herein comprise a multi-objective time-indexed formulation of a task migration and placement problem. A framework, or model, for accurately describing the state of a data center is achieved by considering (i) a set of machines, (ii) the network topology connecting them, and (iii) a set of tasks to allocate on these machines. As the model considers workload migration, for which it is necessary to be aware of the evolution of the state of the data center, the model assumes a discretized time denoted by t∈N. A summary of the notations used throughout this document is provided in Table 1 below.

TABLE 1

| Notation | Description |
|---|---|
| i,i′, . . . ∈ T | Tasks |
| j,j′, . . . ∈ M | Machines |
| s,s′, . . . ∈ S | Switches |
| A ⊆ (M ∪ S)² | Network edges |
| A_{jj′} ∈ 2^{A} | Path j [symbol] j′ |
| cᵤᵥ > 0 | Capacity of link (u, v) |
| wⱼ > 0 | Machine CPU capacity |
| rᵢ > 0 | Task CPU requirement |
| sᵢ > 0 | Task size |
| pᵢ^{t} ∈ {0, 1} | Task is runnable |
| C^{t} ⊆ T² | Communicating tasks |
| m_{ii′}^{t} > 0 | Throughput demand for i [symbol] i′ |
| xᵢⱼ^{t} ∈ {0, 1} | Task i is on machine j |
| f_{ii′}^{t}(u, v) ≥ 0 | Flow for i [symbol] i′ along (u, v) |

Tasks are represented by a set T. At any given time, new tasks can arrive or existing tasks can finish executing. For ease of notation, T is not time-dependent but represents all tasks that will possibly exist at any time. An input p is then used to specify which tasks are part of the system: at a given time t, a task i∈T can be runnable (pᵢ^{t}=1) or off (pᵢ^{t}=0).

Machines are represented by a set M. Each machine j∈M has a CPU capacity wⱼ>0 which represents the amount of work it can accommodate. Conversely, each task i∈T has a CPU requirement rᵢ>0, representing the amount of resources it needs in order to run. Finally, each task i∈T has a size (for instance, the size of RAM plus storage for a virtual machine) sᵢ>0. This size will be used to model the cost of migrating the task from one machine to another.

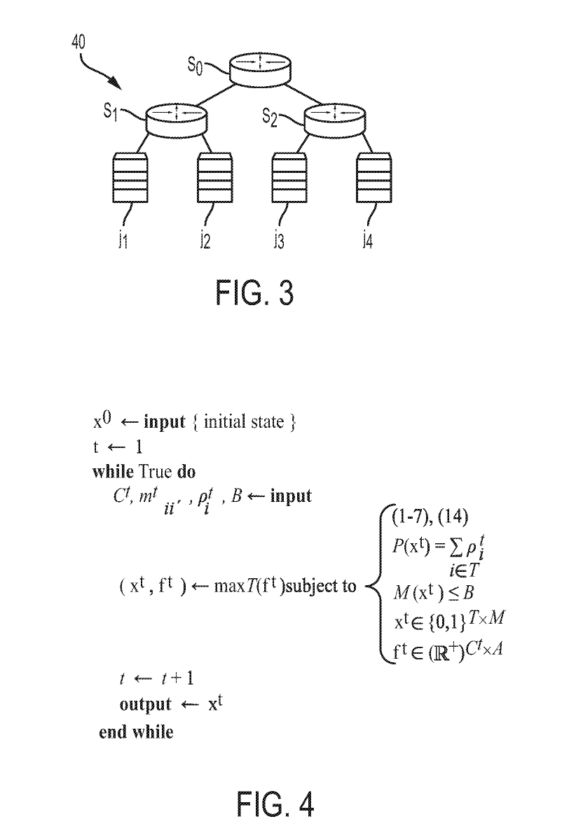

In order to take application dependencies into account, the physical network topology existing between the machines must be known. To that end, the network is modeled as an oriented graph G=(V, A), where V=M U S is the set of vertices, with S the set of switches (which term includes any forwarding node in the network, regardless of whether it is a switch or a router), and A the set of arcs. An arc (u, v) E A can exist between two switches or between a machine and a switch, but also between a machine and itself to model a loopback interface (so that two tasks on the same machine can communicate). Each of those arcs represents a link in the network, and has a capacity of cᵤᵥ>0. For each ordered pair of machines (j, j′)∈M², a list A_{jj′}∈2^{A} represents the path from j to j′. For example, given the highly simplified topology depicted in FIG. 3, which illustrates a network 40 including a plurality of switches represented in FIG. 3 by switches s0, s1, s2, and a plurality of machines represented in FIG. 3 by machines j1, j2, j3, j4, the corresponding graph will be A={(j1, j1), (j1, s1), (s1, j1), (j2, j2), (j2, s1), (s1, j2), (j3, j3), (j3, s2), (s2, j3), (j4, j4), (j4, s2), (s2, j4), (s1, s0), (s0, s1), (s2, s0), (s0, s2)}. The path from j1 to j3, for example, will be Aⱼ₁ⱼ₃={(j1, s1), (s1, s0), (s0, s2), (s2, j3)}.

At a given time t, an ordered pair of tasks (i, i′)∈T² can communicate with a throughput demand m_{ii′}^{t}1>0, representing the throughput at which i would like to send data to I′. Let G_{d}^{t}=(T, C^{t}) be a weighted oriented graph representing these communication demands, where each arc (i, i′)∈C^{t} is weighted by m_{ii′}^{t}. G_{d}^{t} will be referred to as the throughput demand graph.

The data center framework described above may be used to present a multi-objective Mixed Integer Non-Linear Program (“MINLP”) aiming at optimizing workload allocation and migration while satisfying inter-application network demands. A linearization as a multi-objective MILP is then derived, allowing for an easier resolution. The variables, constraints, and objective functions that constitute the model are described as follows.

In particular, two sets of variables are necessary, one representing task placement and the other representing the network flow for a particular allocation. With regard to task placement, the model seeks to provide a placement of each task i∈T on a machine j∈M at a given timestep t. The binary variable xᵢⱼ^{t} reflects this allocation: xᵢⱼ^{t}=1 if i is placed on j, and xᵢⱼ^{t}=0 otherwise.

With regard to network awareness, in order to discern the best throughput that can be achieved between each pair of communicating tasks, a variant of the multi-commodity flow problem is used, where a commodity is defined by the existence of (i, i′)∈C^{t}. For each (u, v)∈A, f_{ii′}^{t} (u, v) is a variable representing the throughput for communication from i to i′ along the link (u, v).

Two sets of constraints are used to model this flow-aware workload migration problem: allocation constraints (equations 1-3) represent task allocation, whereas flow constraints (equations 4-8) focus on network flow computation. The allocation constraints represent the relationship between tasks and machines. First, each task i∈T must be placed on at most one machine, but of course on none of them if it is not runnable at this time (i.e., if ρᵢ^{t}=0):

$${\sum }_{j ∈ M} {x}_{ij}^{t} \leq {ρ}_{i}^{t} , ∀ i ∈ T \qquad ( 1 )$$

Furthermore, forcefully terminating a task is not desirable: an already placed task must have priority over newly runnable ones. Hence, if the model placed a task at iteration t−1, which is still part of the set of runnable tasks at iteration t, it must not be forcefully terminated:

$${ρ}_{i}^{t} {\sum }_{j ∈ M} {x}_{ij}^{t - 1} \leq {\sum }_{j ∈ M} {x}_{ij}^{t} , ∀ i ∈ T \qquad ( 2 )$$

where xᵢⱼ^{t-1} is a known input given by the state of the system at time t−1.

Finally, the tasks on a machine cannot use more CPU resources than the capacity of that machine:

$${\sum }_{i ∈ T : {ρ}_{i}^{t} = 1} {r}_{i}^{t} {x}_{ij}^{t} \leq {w}_{j} , ∀ j ∈ M \qquad ( 3 )$$

The flow constraints allow computing the throughput for each commodity. For each link (u, v)∈A in the network the total flow along the link must not exceed its capacity:

$${\sum }_{( i , {i}^{′} ) ∈ {C}^{i}} {f}_{{ii}^{′}}^{t} ( u , v ) \leq {c}_{uv} , ∀ ( u , v ) ∈ A \qquad ( 4 )$$

For a commodity (i, i′)∈C^{t}, the flow going out of a machine j must not exceed the throughput demand for the communication from i to i′. Also, the flow must be zero if task i is not hosted by machine j:

$${\sum }_{v : ( j , v ) ∈ A} {f}_{{ii}^{′}}^{t} ( j , v ) \leq {m}_{{ii}^{′}}^{t} , {x}_{ij}^{t} , ∀ j ∈ M , ∀ ( i , {i}^{′} ) ∈ {C}^{t} \qquad ( 5 )$$

Conversely, the flow entering a machine j′ must not exceed the throughput demand for the communication from i to i′ and must be set to zero if task i′ is not on j′:

$${\sum }_{v : ( v , {j}^{′} ) ∈ A} {f}_{{ii}^{′}}^{t} ( v , {j}^{′} ) \leq {m}_{{ii}^{′}}^{t} , {x}_{{i}^{′} {j}^{′}}^{t} , ∀ {j}^{′} ∈ M , ∀ ( i , {i}^{′} ) ∈ {C}^{t} \qquad ( 6 )$$

Each switch s∈S must forward the flow for each commodity; that is, the ingress flow must be equal to the egress flow:

$${\sum }_{v : ( u , v ) ∈ A} {f}_{{ii}^{′}}^{t} ( u , v ) = {\sum }_{v : ( v , u ) ∈ A} {f}_{{ii}^{′}}^{t} ( v , u ) , ∀ u ∈ S , ∀ ( i , {i}^{′} ) ∈ {C}^{t} \qquad ( 7 )$$

Finally, if a task i is placed on machine j and a task i′ is on machine j′, it is necessary to make sure that the corresponding flow goes through the path specified by A^{jj′}. Otherwise, the flow computed by the model could go through a non-optimal path or take multiple parallel paths, which does not accurately reflect what happens in a real IP network. Hence, the flow needs to be set to zero for all edges that do not belong to the path from j to j′:

f_{ii′}^{t}(u,v)≤cᵤᵥ(1−xᵢⱼ^{t}x_{i′j′}^{t}),

∀(i,i′)∈C^{t},∀j,j′∈M,∀(u,v)∈A\A_{jj′} (8)

Note that this constraint has no side effect if task i is not on j or task i′ is not on j′, since in this case, it reduces to f_{ii′}^{t} (u, v)≤cᵤᵥ, which is already covered by equation (4).

The migration module as presented herein introduces three different objective functions, modeling (i) the placement of tasks, (ii) the overall throughput achieved in the network, and (iii) the cost incurred by task migration. These functions depend on allocation, i.e., on an assignment of all variables x_{ii′}^{t} and f_{ii′}^{t} (u, v). Let x^{t} (resp. f^{t}) be the characteristic vectors of the variables x_{ii′}^{t} (resp. f_{ii′}^{t} (u, v)).

The placement objective is simple and expresses that a maximum number of tasks should be allocated to some machines. When removing task dependencies from the model, it becomes a standard assignment problem whereby each task should be placed to a machine satisfying its CPU requirement, while also not exceeding the machine capacity. The placement objective function is simply the number of tasks that are successfully allocated to a machine:

$$P ( {x}^{t} ) = {\sum }_{i ∈ T} {\sum }_{j ∈ M} {x}_{ij}^{t} \qquad ( 9 )$$

The throughput objective expresses the need to satisfy applications' throughput demands at best. Modeling network dependencies between workloads in a data center is often done through the use of a cost function depending on the network distance between two machines. Having introduced an accurate representation of the physical network and of applications dependencies above, it is possible to use this framework to represent the overall throughput reached in the data center. To compute the throughput of the communication from a task i to a task i′, it suffices to identify the machine j on which i is running and take the flow out of this machine for this commodity:

$${\sum }_{j ∈ M} {x}_{ij}^{t} {\sum }_{v : ( j , v ) ∈ A} {f}_{{ii}^{′}}^{t} ( j , v )$$

This expression is quadratic in variables x_{ii′}^{t} and f_{ii′}^{t} (u, v), but, due to the fact that equation (5) constrains the flow to be zero for machines to which i is not assigned, can be simplified to:

$${\sum }_{j ∈ M} {\sum }_{v : ( j , v ) ∈ A} {f}_{{ii}^{′}}^{t} ( j , v )$$

Therefore, the overall throughput in the data center may be expressed as:

$$T ( {f}^{t} ) = {\sum }_{( i , {i}^{′} ) ∈ {C}^{t}} {\sum }_{j ∈ M} {\sum }_{v : ( j , v ) ∈ A} {f}_{{ii}^{′}}^{t} ( j , v ) \qquad ( 10 )$$

Finally, the migration cost allows the cost of reallocating tasks from one machine to another to be taken into account. The fundamental assumption made here is that tasks in a data center have communication demands that may evolve over time (modeled by m_{ii′}^{t}). This means that migrating a task to a machine closer to those machines hosting other tasks with which it communicates can be a simple way to achieve overall better performance. However, such migrations have a cost. To model this cost, it is necessary to compute which tasks have been moved to a new machine between two successive times t−1 and t. When running the model at time t, the assignment x^{t l} is known, allowing knowing if task l has moved by comparing x^{t} to x^{t l}. Also, care must be taken in order to discriminate between task migration and task shutdown: if a task is no longer runnable (ρ^{t}=0), it must not be part of the computation of the number of migrated tasks. Using sᵢ to model the cost of migrating a task i from one machine to another, the total migration cost from time t−1 to time t can be expressed as:

$$M ( {x}^{t} ) = {\sum }_{i ∈ T} {\sum }_{j ∈ M} {s}_{i} {x}_{ij}^{t - 1} ( 1 - {x}_{ij}^{t} ) {ρ}_{i}^{t} \qquad ( 11 )$$

Using these three objectives, it is possible to express the flow-aware placement and migration model as a multi-objective MILNP:

$$( 𝒫 ) \{ \begin{matrix}max T ( {f}^{t} ) \\ max P ( {x}^{t} ) \\ min M ( {x}^{t} ) \\ subject to \{ \begin{matrix}( 1 - 8 ) \\ {x}^{t} ∈ {\{ 0 , 1 \}}^{\vert T \vert \times \vert M \vert} \\ {f}^{t} ∈ {( {ℝ}^{+} )}^{\vert {C}^{t} \vert \times \vert A \vert}\end{matrix}\end{matrix} \qquad ( 12 )$$

It is important to note that these three objectives tend to compete with each other. If a task starts communicating with another task, migrating it to the same machine, or to a machine closer in the topology can increase throughput objective function, but this will increase the migration cost. For the placement objective, equation (2) prevents tasks which were running at t 1 and which are still runnable from being killed. Hence, increasing the placement objective can only be done by deciding to place a new runnable task on some machine. However, placing a new task can use CPU capacity that could have been utilized to migrate an already running task and increase its throughput: increasing the overall placement is not necessarily beneficial to the other objectives.

All constraints introduced hereinabove are linear with respect to the variables xᵢⱼ^{t} and f_{ii′}^{t} (u, v), except for the path enforcement constraint given by equation (8). By exploiting the fact that xᵢⱼ^{t}∈{0, 1}, this set of constraints can be linearized:

f_{ii′}^{t}(u,v)≤cᵤᵥ(2−xᵢⱼ^{t}x_{i′j′}^{t}),

∀(i,i′)∈C^{t},∀j,j′∈M,∀(u,v)∈A\A_{jj′} (13)

FIG. 4 illustrates a multi-objective migration algorithm in accordance with features of embodiments described herein. As shown in FIG. 4, if xᵢⱼ^{t} x_{i′j′}^{t}≠1, the equation will be f_{ii′}^{t} (u, v)≤cᵤᵥ or f_{ii′}^{t} (u, v)≤2 cᵤᵥ and will therefore be superseded by equation (4). This set of constraints can be further compressed by writing only one equation per machine j∈M instead of one per tuple j, j′∈M. This does not alter the model and makes the formulation more compact as follows:

$${f}_{{ii}^{′}}^{t} ( u , v ) \leq {c}_{uv} ( 2 - {x}_{ij}^{t} - {\sum }_{{j}^{′} ∈ M : ( u , v ) ∉ {A}_{{jj}^{′}}} {x}_{{i}^{′} {j}^{′}}^{t} ) , \\ ∀ ( i , {i}^{′} ) ∈ {C}^{t} , ∀ j ∈ M , ∀ ( u , v ) ∈ A \qquad ( 14 )$$

Therefore, the flow-aware workload migration problem may be given by the following multi-objective MILP:

$$( {𝒫}^{′} ) \{ \begin{matrix}max T ( {f}^{t} ) \\ max P ( {x}^{t} ) \\ min M ( {x}^{t} ) \\ subject to \{ \begin{matrix}( 1 - 7 ) , ( 14 ) \\ {x}^{t} ∈ {\{ 0 , 1 \}}^{\vert T \vert \times \vert M \vert} \\ {f}^{t} ∈ {( {ℝ}^{+} )}^{\vert {C}^{t} \vert \times \vert A \vert}\end{matrix}\end{matrix} \qquad ( 15 )$$

As will be described in greater detail hereinbelow, the multi-objective MILP of equation (15) may be adapted to the media data center use case. For the media data center scenario, a primary simplifying assumption is that there is always room for all tasks to run. Therefore, the placement objective is no more considered during the resolution of them multi-objective MILP. Instead, a constraint is added that all runnable tasks must be placed, which translates to:

$$P ( {x}^{t} ) = {\sum }_{i ∈ T} {ρ}_{i}^{t}$$

If this constraint cannot be satisfied, it means that there are not enough resources to run all of the workloads and the algorithm fails.

Furthermore, it will be assumed that the policy aims at favoring an allocation that provides the best throughput possible, regardless of the number of migrated tasks. To model this choice, a migration budget B≥0, representing the maximum migration cost affordable for one run, will be assumed. Then, the migration cost is no more to be minimized, but is turned into a constraint bounding the possible number of migrations. This allows for simplification of the multi-objective MILP of equation (15) into a single-objective one:

$$( {𝒫}_{s} ) \{ \begin{matrix}max T ( {f}^{t} ) \\ subject to \{ \begin{matrix}( 1 - 7 ) , ( 14 ) \\ P ( {x}^{t} ) = {\sum }_{i ∈ T} {ρ}_{i}^{t} \\ M ( {x}^{t} ) \leq B \\ {x}^{t} ∈ {\{ 0 , 1 \}}^{T \times M} \\ {f}^{t} ∈ {( {ℝ}^{+} )}^{{C}^{t} \times A}\end{matrix}\end{matrix} \qquad ( 16 )$$

The algorithm presented in FIG. 4 presents the procedure to iteratively run the MILP of equation (16). The algorithm runs at each time step t, taking current inter-application communication requirements as inputs and returning a new allocation as a solution. If the throughput demands between applications never change and new applications never arrive, it suffices to run the algorithm for only t=0. If the problem is to find an optimal initial allocation, one can set x⁰ to random values and B=∞. This will basically begin from a random virtual allocation and allow every task in the virtual allocation to be migrated so that an optimal initial allocation can be determined.

Turning now to FIG. 5, illustrated therein is a flowchart showing example steps of a technique for optimizing workload placement and resource allocation for a network (e.g., a media production data center) in accordance with embodiments described herein. Referring to FIG. 5, in step 70, a network of interest comprising a set of compute nodes is characterized. In particular, each compute node of the set of compute nodes comprising the network of interest may be characterized as to the node's CPU capacity, memory capacity, GPU capacity, and/or storage capacity, for example. Additionally, each link between compute nodes in the network may be characterized as to bandwidth, for example. In step 72, a set of workloads (which together may comprise an application), or tasks, is characterized. In particular, each workload, or task, may be characterized as to CPU requirements, memory requirements, storage requirements, and/or GPU requirements, for example. Additionally, each interaction between workloads, or tasks, may be characterized as to throughput demand, for example. In step 74, an attempt is made to assign each of the workloads to one of the compute nodes based on the network and application constraints (i.e., the characterization of the network as compared to the workload characterization. In certain embodiments, (1) task and inter-task requirements must be met in placing the workloads on compute nodes; and (2) workloads will be placed in a manner that favors the best throughput available. Step 74 may be accomplished using the MILP model described above and the algorithm illustrated in FIG. 4.

In step 76, a determination is made whether all of the workloads have been placed on a compute node. If not, execution proceeds to step 78, in which a failure is declared, and then to step 80 in which execution terminates. If a positive determination is made in step 76, execution proceeds directly to step 80. It will be recognized that the steps illustrated in FIG. 5 may be repeated at any time, but are particularly repeated in response to a change in either the network itself (e.g., addition, removal, and/or movement of a network node) or the number, identity, and/or requirements of workloads.

In example implementations, at least some portions of the activities related to the techniques described herein may be implemented in software in, for example, a server, a router, etc. In some embodiments, this software could be received or downloaded from a web server, provided on computer-readable media, or configured by a manufacturer of a particular element in order to provide this system in accordance with features of embodiments described herein. In some embodiments, one or more of these features may be implemented in hardware, provided external to these elements, or consolidated in any appropriate manner to achieve the intended functionality.

While processing high-bandwidth and possibly uncompressed media (e.g., video) on a network, losing packets can have a dramatic effect on the quality of experience (e.g., due to loss of one or more frames). A naive workload scheduler could place tasks such that some resulting flows are competing for bandwidth over a bottleneck. In contrast, embodiments described herein addresses this situation by ensuring the definition and formulation of clear inter-task demands and further ensuring that such inter-task demands are considered and respected in placing the corresponding tasks so as to avoid such bottlenecks, for example.

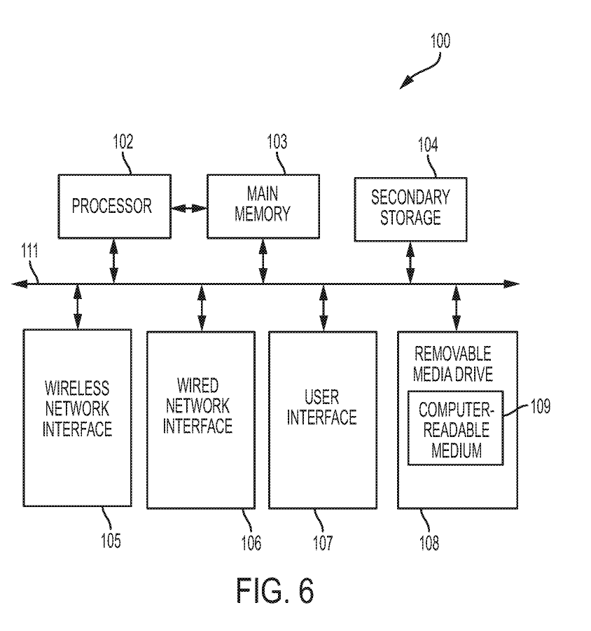

Turning now to FIG. 6, illustrated therein is a simplified block diagram of an example machine (or apparatus) 100, which in certain embodiments may be an network node, that may be implemented in embodiments described herein. The example machine 100 corresponds to network elements and computing devices that may be deployed in a communications network, such as a network node. In particular, FIG. 6 illustrates a block diagram representation of an example form of a machine within which software and hardware cause machine 100 to perform any one or more of the activities or operations discussed herein. As shown in FIG. 6, machine 100 may include a processor 102, a main memory 103, secondary storage 104, a wireless network interface 105, a wired network interface 106, a user interface 107, and a removable media drive 108 including a computer-readable medium 109. A bus 101, such as a system bus and a memory bus, may provide electronic communication between processor 102 and the memory, drives, interfaces, and other components of machine 100.

Processor 102, which may also be referred to as a central processing unit (“CPU”), can include any general or special-purpose processor capable of executing machine readable instructions and performing operations on data as instructed by the machine-readable instructions. Main memory 103 may be directly accessible to processor 102 for accessing machine instructions and may be in the form of random access memory (“RAM”) or any type of dynamic storage (e.g., dynamic random-access memory (“DRAM”)). Secondary storage 104 can be any non-volatile memory such as a hard disk, which is capable of storing electronic data including executable software files. Externally stored electronic data may be provided to computer 100 through one or more removable media drives 108, which may be configured to receive any type of external media such as compact discs (“CDs”), digital video discs (“DVDs”), flash drives, external hard drives, etc.

Wireless and wired network interfaces 105 and 106 can be provided to enable electronic communication between machine 100 and other machines, or nodes. In one example, wireless network interface 105 could include a wireless network controller (“WNIC”) with suitable transmitting and receiving components, such as transceivers, for wirelessly communicating within a network. Wired network interface 106 can enable machine 100 to physically connect to a network by a wire line such as an Ethernet cable. Both wireless and wired network interfaces 105 and 106 may be configured to facilitate communications using suitable communication protocols such as, for example, Internet Protocol Suite (“TCP/IP”). Machine 100 is shown with both wireless and wired network interfaces 105 and 106 for illustrative purposes only. While one or more wireless and hardwire interfaces may be provided in machine 100, or externally connected to machine 100, only one connection option is needed to enable connection of machine 100 to a network.

A user interface 107 may be provided in some machines to allow a user to interact with the machine 100. User interface 107 could include a display device such as a graphical display device (e.g., plasma display panel (“PDP”), a liquid crystal display (“LCD”), a cathode ray tube (“CRT”), etc.). In addition, any appropriate input mechanism may also be included such as a keyboard, a touch screen, a mouse, a trackball, voice recognition, touch pad, etc.

Removable media drive 108 represents a drive configured to receive any type of external computer-readable media (e.g., computer-readable medium 109). Instructions embodying the activities or functions described herein may be stored on one or more external computer-readable media. Additionally, such instructions may also, or alternatively, reside at least partially within a memory element (e.g., in main memory 103 or cache memory of processor 102) of machine 100 during execution, or within a non-volatile memory element (e.g., secondary storage 104) of machine 100. Accordingly, other memory elements of machine 100 also constitute computer-readable media. Thus, “computer-readable medium” is meant to include any medium that is capable of storing instructions for execution by machine 100 that cause the machine to perform any one or more of the activities disclosed herein.

Not shown in FIG. 6 is additional hardware that may be suitably coupled to processor 102 and other components in the form of memory management units (“MMU”), additional symmetric multiprocessing (“SMP”) elements, physical memory, peripheral component interconnect (“PCI”) bus and corresponding bridges, small computer system interface (“SCSI”)/integrated drive electronics (“IDE”) elements, etc. Machine 100 may include any additional suitable hardware, software, components, modules, interfaces, or objects that facilitate the operations thereof. This may be inclusive of appropriate algorithms and communication protocols that allow for the effective protection and communication of data. Furthermore, any suitable operating system may also be configured in machine 100 to appropriately manage the operation of the hardware components therein.

The elements, shown and/or described with reference to machine 100, are intended for illustrative purposes and are not meant to imply architectural limitations of machines such as those utilized in accordance with the present disclosure. In addition, each machine may include more or fewer components where appropriate and based on particular needs. As used herein in this Specification, the term “machine” is meant to encompass any computing device or network element such as servers, routers, personal computers, client computers, network appliances, switches, bridges, gateways, processors, load balancers, wireless LAN controllers, firewalls, or any other suitable device, component, element, or object operable to affect or process electronic information in a network environment.

In example implementations, at least some portions of the activities described herein may be implemented in software in. In some embodiments, this software could be received or downloaded from a web server, provided on computer-readable media, or configured by a manufacturer of a particular element in order to implement the embodiments described herein. In some embodiments, one or more of these features may be implemented in hardware, provided external to these elements, or consolidated in any appropriate manner to achieve the intended functionality.

Furthermore, in the embodiments described and illustrated herein, some of the processors and memory elements associated with the various network elements may be removed, or otherwise consolidated such that a single processor and a single memory location are responsible for certain activities. Alternatively, certain processing functions could be separated and separate processors and/or physical machines could implement various functionalities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of the example embodiments, one or more memory elements (e.g., main memory 103, secondary storage 104, computer-readable medium 109) can store data used in implementing embodiments described and illustrated herein. This includes at least some of the memory elements being able to store instructions (e.g., software, logic, code, etc.) that are executed to carry out the activities described in this Specification. A processor can execute any type of instructions associated with the data to achieve the operations detailed herein in this Specification. In one example, one or more processors (e.g., processor 102) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable read only memory (“EEPROM”)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

Components of communications network described herein may keep information in any suitable type of memory (e.g., random access memory (“RAM”), read-only memory (“ROM”), erasable programmable ROM (“EPROM”), electrically erasable programmable ROM (“EEPROM”), etc.), software, hardware, or in any other suitable component, device, element, or object where appropriate and based on particular needs. Any of the memory items discussed herein should be construed as being encompassed within the broad term “memory element.” The information being read, used, tracked, sent, transmitted, communicated, or received by network environment, could be provided in any database, register, queue, table, cache, control list, or other storage structure, all of which can be referenced at any suitable timeframe. Any such storage options may be included within the broad term “memory element” as used herein. Similarly, any of the potential processing elements and modules described in this Specification should be construed as being encompassed within the broad term “processor.”

Note that with the example provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that topologies illustrated in and described with reference to the accompanying FIGURES (and their teachings) are readily scalable and can accommodate a large number of components, as well as more complicated/sophisticated arrangements and configurations. Accordingly, the examples provided should not limit the scope or inhibit the broad teachings of the illustrated topologies as potentially applied to myriad other architectures.

It is also important to note that the steps in the preceding flow diagrams illustrate only some of the possible signaling scenarios and patterns that may be executed by, or within, communication systems shown in the FIGURES. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication systems shown in the FIGURES in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular communication exchanges, embodiments described herein may be applicable to other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 142 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method comprising:
characterizing by a controller comprising a processor and a memory unit a set of compute nodes, wherein the set of compute nodes comprise a network;
characterizing by the controller a set of workloads, wherein the set of workloads comprise at least one application executing on the network;
for each workload of the set of workloads, attempting by the controller to assign the workload to a compute node of the set of compute nodes based on the characterizing the set of compute nodes and the characterizing the set of workloads;
determining by the controller whether each one of the workloads of the set of workloads has been successfully assigned to a compute nodes of the set of compute nodes; and
if each one of the workloads of the set of workloads has been successfully assigned to a compute node of the set of compute nodes, awaiting by the controller a change in at least one of the set of compute nodes and the set of workloads.

2. The method of claim 1 further comprising, if at least one of the workloads of the set of workloads has not been successfully assigned to a compute node of the set of compute nodes, concluding that the attempting to assign has failed.

3. The method of claim 2 further comprising, subsequent to concluding that the attempting to assign has failed, awaiting a change in at least one of the set of compute nodes and the set of workloads.

4. The method of claim 1 further comprising, subsequent to the awaiting a change in at least one of the set of compute nodes and the set of workloads, if the change is detected, repeating the characterizing and attempting to assign for the changed set of compute nodes and then changed set of workloads.

5. The method of claim 1, wherein the network comprises a media production data center.

6. The method of claim 1, wherein the characterizing a set of compute nodes comprises, for each compute node of the set of compute nodes:
determining at least one of a central processing unit (“CPU”) capacity of the node, a memory capacity of the node, a graphics processing unit (“GPU”) capacity of the node, and a storage capacity of the compute node; and
for each link connected to the compute node, determining a bandwidth of the link.

7. The method of claim 1, wherein the characterizing a set of workloads comprises, for each of workload of the set of workloads:
determining at least one of central processing unit (“CPU”) requirements of the workload, memory requirements of the workload, storage requirements of the workload, and graphics processing unit (“GPU”) requirements of the workload; and
for each interaction by the workload with another workload of the set of workloads, determining a throughput demand of the interaction.

8. One or more non-transitory tangible media that includes code for execution and when executed by a processor is operable to perform operations comprising:
characterizing a set of compute nodes, wherein the set of compute nodes comprise a network;
characterizing a set of workloads, wherein the set of workloads comprise at least one application executing on the network;
for each workload of the set of workloads, attempting to assign the workload to a compute node of the set of compute nodes based on the characterizing the set of compute nodes and the characterizing the set of workloads;
determining whether each one of the workloads of the set of workloads has been successfully assigned to a compute nodes of the set of compute nodes; and
if each one of the workloads of the set of workloads has been successfully assigned to a compute node of the set of compute nodes, awaiting a change in at least one of the set of compute nodes and the set of workloads.

9. The media of claim 8, wherein the operations further comprise, if at least one of the workloads of the set of workloads has not been successfully assigned to a compute node of the set of compute nodes, concluding that the attempting to assign has failed.

10. The media of claim 9, wherein the operations further comprise, subsequent to concluding that the attempting to assign has failed, awaiting a change in at least one of the set of compute nodes and the set of workloads.

11. The media of claim 8, wherein the operations further comprise, subsequent to the awaiting a change in at least one of the set of compute nodes and the set of workloads, if the change is detected, repeating the characterizing and attempting to assign for the changed set of compute nodes and then changed set of workloads.

12. The media of claim 8, wherein the characterizing a set of compute nodes comprises, for each compute node of the set of compute nodes:
determining at least one of a central processing unit (“CPU”) capacity of the node, a memory capacity of the node, a graphics processing unit (“GPU”) capacity of the node, and a storage capacity of the compute node; and
for each link connected to the compute node, determining a bandwidth of the link.

13. The media of claim 8, wherein the characterizing a set of workloads comprises, for each of workload of the set of workloads:
determining at least one of central processing unit (“CPU”) requirements of the workload, memory requirements of the workload, storage requirements of the workload, and graphics processing unit (“GPU”) requirements of the workload; and
for each interaction by the workload with another workload of the set of workloads, determining a throughput demand of the interaction.

14. An apparatus comprising:
a memory element configured to store data; and
a processor operable to execute instructions associated with the data;
the apparatus configured for:
characterizing a set of compute nodes, wherein the set of compute nodes comprise a network;
characterizing a set of workloads, wherein the set of workloads comprise at least one application executing on the network;
for each workload of the set of workloads, attempting to assign the workload to a compute node of the set of compute nodes based on the characterizing the set of compute nodes and the characterizing the set of workloads;
determining whether each one of the workloads of the set of workloads has been successfully assigned to a compute nodes of the set of compute nodes; and
if each one of the workloads of the set of workloads has been successfully assigned to a compute node of the set of compute nodes, awaiting a change in at least one of the set of compute nodes and the set of workloads.

15. The apparatus of claim 14 further configured for, if at least one of the workloads of the set of workloads has not been successfully assigned to a compute node of the set of compute nodes, concluding that the attempting to assign has failed.

16. The apparatus of claim 15 further configured for, subsequent to concluding that the attempting to assign has failed, awaiting a change in at least one of the set of compute nodes and the set of workloads.

17. The apparatus of claim 14 further configured for, subsequent to the awaiting a change in at least one of the set of compute nodes and the set of workloads, if the change is detected, repeating the characterizing and attempting to assign for the changed set of compute nodes and then changed set of workloads.

18. The apparatus of claim 14, wherein the network comprises a media production data center.

19. The apparatus of claim 14, wherein the characterizing a set of compute nodes comprises, for each compute node of the set of compute nodes:
determining at least one of a central processing unit (“CPU”) capacity of the node, a memory capacity of the node, a graphics processing unit (“GPU”) capacity of the node, and a storage capacity of the compute node; and
for each link connected to the compute node, determining a bandwidth of the link.

20. The apparatus of claim 14, wherein the characterizing a set of workloads comprises, for each of workload of the set of workloads:
determining at least one of central processing unit (“CPU”) requirements of the workload, memory requirements of the workload, storage requirements of the workload, and graphics processing unit (“GPU”) requirements of the workload; and
for each interaction by the workload with another workload of the set of workloads, determining a throughput demand of the interaction.
